(19) United States
(12) Patent Application Publication
(10) Pub. No.: US 2011/0265359 A1
(43) Pub. Date: Nov. 3, 2011

(54) POINT-OF-PURCHASE MARKETING SIGNAGE METHOD AND APPARATUS

(76) Inventor: Lynne M. McNamee, Milford, CT (US)

(21) Appl. No.: 13/185,230

(22) Filed: Jul. 18, 2011

Related U.S. Application Data
(63) Continuation-in-part of application No. 12/498,920, filed on Jul. 7, 2009, now abandoned.
Application No. 12/498,920 is a continuation-in-part of application No. 11/871,509, filed on Oct. 12, 2007, now abandoned.
(60) Provisional application No. 60/851,043, filed on Oct. 12, 2006.

(51) Int. Cl. G09F 1/08; G09F 7/12; G09F 7/00

(52) U.S. Cl. 40/539; 40/538; 40/584; 40/594

(57) ABSTRACT

Apparatus and method for marketing products that includes a plastic, magnetic or lenticular form typically conforming in shape and size of a corresponding product being advertised and the form may have indicia applied to the form representative of information associated with the advertised product. In another aspect, an apparatus for signage is provided that includes a plastic or similar material pocket for insertion of marketing material.

This application is a continuation-in-part (CIP) of U.S. Non-Provisional application Ser. No. 12/498,920, filed Jul. 7, 2009, entitled POINT-OF-PURCHASE MARKETING SIGNAGE METHOD AND APPARATUS, which is a continuation-in-part (CIP) of U.S. Non-Provisional application Ser. No. 11/871,509, filed Oct. 12, 2007, entitled POINT-OF-PURCHASE MARKETING SIGNAGE METHOD AND APPARATUS, which claims priority and benefit to U.S. Provisional application no. 60/851,043, filed Oct. 12, 2006, and entitled POINT-OF-PURCHASE MARKETING SIGNAGE METHOD AND APPARATUS, the disclosures of each are incorporated by reference herein in their entirety.

### BACKGROUND OF THE INVENTION

1. Field of the Invention

The invention relates to an advertising device and method, specifically an advertising device and method for use in retail marketing displays and other types of promotional displays.

2. Related Art

The retail marketing arena is highly competitive, with an ever expanding number of products coming to market and seeking distribution to, awareness of and purchase by consumers. Within a wine and liquor retail environment, typical stores have racks where a bottle of wine rests at an angle, for example 45°, so that consumers may easily read the label on the bottle. Other bottles of wine and various spirits stand upright, again for ease of visibility and convenience of storage. However, if the most visible location for a container of that product does not contain the packaged item, for example, the top of the rack or at the front of the standing row of bottles, a consumer may not (and probably would not) know that that product was there, especially if not already familiar with that brand, vintage, or type.

Similarly, in retail arenas like grocery stores, ‘big box’ stores, hardware stores, etc., visibility is critical for completing a sale. If a consumer cannot find a product, or is unaware of a product, he/she will not buy that product. Especially considering the depth of many retail shelving units, when the most forward units of a product are moved or removed, it is hard to tell if a store carries a product or where to even look to see if more units are available. This problem is exacerbated as more stores change their shelf labels to incorporate their internal coding and SKU (stock keeping unit) references, rather than spelling out what product is assigned to a particular space.

In addition, for products on lower shelves, it is especially difficult to find where a product should be, or to take notice of new products, when the front units have been moved or removed. When a person has physical limitations or is elderly with limited movement, this visibility problem becomes more significant.

Packaging serves as the primary method of Point of Purchase (POP) education and persuasion. In addition to the brand, product name and other selling information about the product appearing on package labels, incentives and promotions frequently accompany the packaging, using “hang tags” (on the bottles themselves), “stickers” (on packaging labels), “shelf talkers” and “wobblers” (both which protrude from the shelving units). These additions to the labels and packaging provide additional space to communicate benefits of the product, discounts, co-promotions (with other brands), suggested uses, etc. If the most visible part of the product units is not viewable, consumers will not be aware of them and, thus these incentives are ineffectual. The above positions the marketing and selling challenges that must be confronted by companies and entities wishing to sell in a retail environment. However, there are physical challenges as well.

The two most significant physical challenges for signage or other forms of promotion within a retail setting are:
1. Merchandise is moved or rotated throughout the store on a regular basis, and
2. The display units used by retail establishments physically vary, not only between store chains and store locations, but even within a single retail location.

These physical considerations place constraints on what marketing and sales promotion materials and methods are available for use, especially in the effort to mass produce and install such units in a means that is cost effective and, therefore, available to companies of all sizes, and not just the largest (and most well funded) of those companies.

### SUMMARY OF THE INVENTION

In light of the above, this invention intends to offer an advertising process and signage to benefit consumers, manufacturers and retail marketers. The advancement includes a marketing device that provides a cost efficient way to mass produce marketing and promotional sales signage to be used in store that can easily be moved throughout a store while accommodating the variety of sizes and configurations of the shelving and racking units within that store. Additionally, in one aspect, the device constructed according to principles of the invention continues representation of the product and/or marketing incentives once the product in the most visible location is removed, fulfilling a challenge to the marketing and sales promotion process.

In different embodiments, the invention includes providing a process and device for promoting sales of various products in a consumer retail environment at the Point of Purchase by providing a continued or ongoing presence of a product at the Point of Purchase and to further promote a product or incentive.

In one aspect, an apparatus for marketing products is provided that includes a signage configured to represent substantially in shape and size a product being advertised by the die cut signage and the signage adapted to receive indicia representative of information associated with the advertised product and a first self-engaging fastener for securing the signage applied along the extent of the signage and adapted to receive a pair of second self-engaging strips to secure the signage to a rack, wherein the signage has one portion of width above a central horizontal axis different in width than a portion below the central horizontal axis.

In another aspect, an apparatus for advertising is provided that includes a signage having a form corresponding to a general form of an associated product to be advertised wherein the signage has a first surface and a second surface and the signage configured with a fastening mechanism for affixing the signage to a display platform, the fastening mechanism comprising a first fastening portion attached to the second surface and arranged along a length of the signage and at least one second fastening portion configured to engage the first fastening portion, the at least one second fastening portion attachable to a display platform and configured to be engageable with the first fastening portion.

In another aspect, a method of advertising is provided that includes providing a based form substantially sized and shaped to represent an advertised product, applying indicia on the based form representing information associated with the advertised product and placing the based form proximate a location of an actual product represented by the based form and applied indicia to visually convey the advertised product to a potential customer so that the indicia continues to convey the information when the actual product is out of stock or not directly viewable by the potential customer.

In another aspect, an apparatus for marketing products is provided that includes a signage having a front side and a back side and adapted to receive indicia representative of information associated with the advertised product on the front side and a score imparted into a front side of the signage to permit bending of the signage along a width of the signage thereby forming a tab.

In another aspect, an apparatus for marketing products is provided that includes a signage having a front side and a back side and adapted to receive indicia representative of information associated with the advertised product on the front side and a fastener arranged on the back side for attaching the signage to a shelf.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIGS. 1 through 5 are illustrations of embodiments of signage according to principles of the invention;

FIG. 6 is a set of illustrations showing various exemplary shapes signage may take, according to principles of the invention;

FIG. 7 is an exemplary illustration that represents a sample of a square or rectangular sign that can be customized for signage, according to principles of the invention;

FIG. 8 is an exemplary illustration of signage where a portion of the material of signage extends beyond the edge of the shelf or shelving on which the embodiment is used;

FIG. 9 is an illustration of additional aspects of signage that represents a wine bottle of FIG. 1, according to principles of the invention;

FIG. 10A is an illustration that represents a side view with elevation when the advertising device of the invention is produced with a pocket, according to principles of the invention;

FIG. 10B is the illustration of FIG. 10A but showing the insertion of a variable insert into the pocket; and

FIG. 11 is a flow diagram of an embodiment showing steps of making and/or using the signage, according to principles of the invention;

FIG. 12 is an illustration of version of signage representing a wine product, along with attaching mechanisms, configured according to principles of the invention;

FIG. 13 is a rear view of FIG. 12, with attaching mechanism affixed to the back surface, configured according to principles of the invention;

FIG. 14 is an illustration of FIG. 13, with placement of securing strips, configured according to principles of the invention;

FIG. 15A is an illustration of a version of signage, configured according to principles of the invention;

FIG. 15B is a rear view of a portion of the signage of FIG. 15A, configured according to principles of the invention;

FIG. 15C is a side view of an exemplary illustration showing a “double-sided tape” as a fastener mechanism for a signage, constructed according to principles of the invention; and

FIG. 16 is an illustration of a signage similar to FIG. 15A but without a tab portion, constructed according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

In certain aspects, the apparatus and method of the invention provides a semi-permanent marketing apparatus, such as but not limited to signage such as a counter mat-type sign, which may incorporate a plastic pouch and which contains product and/or promotional information. This would be affixed to the shelving rack or unit on which a product was sold. In this way, a continued or ongoing presence of a particular product is maintained even when the actual product or unit is removed or sold. Additional benefits may include maximizing value of space to a retailer and/or product manufacturer who can negotiate space usage, and to a consumer in regards to a continued presence as noted previously as well as advise of additional value-added offers, specials, promotions, etc.

Depending on the environment, the signage of the invention may be provided to a retail location and is professionally produceable, such as but not limited to four-color printed plastic representing a product package, or printed locally from a downloadable file from the manufacturer or distributor or generated in-house by the retailer, such as existing wine notes and ratings, which are insertable into a pouch affixed to the signage on the rack or shelf.

These descriptions herein are examples and are not meant to be considered in a limited sense. There are multiple variations having different modifications that are provided by the invention.

The method for affixing the signs depends upon the type of display unit on which the signs will appear. These display units typically are metal “gondola” shelves or wire wine racks. Many stores have additional types of fixtures for product displays. This device may be adapted for some, but not for all. The primary focus is to provide a solution for adhering signage to metal gondola shelves, which dimensions, including for holes in the flat surfaces of the shelves, are not standard and to wire wine racks, which wire radii, distance between support pieces (vertically and horizontally), angle of display and inclusion/exclusion of additional construction materials and display surfaces vary from rack to rack.

There are two basic categories into which this invention preferably applies, although other categories are possible (such as services). These two preferred categories include: wine/spirits and general packaged goods. For both of these categories, aspects of the invention may include custom die cut or a standard shape. Materials typically are plastic and environmentally friendly plastic variations. In one aspect, the invention may be sizeable according to the needs of the particular retail or other establishment, typically similar to the width or size of the actual product with which the signage may be used in conjunction and/or of sufficient depth (length) to prevent stocking issues. For example, if the signage according to principles of the invention is to promote a ream of paper, the size of the plastic and/or pocket typically is the same or very similar to the width of an actual ream of paper. Another example is in the situation when an embodiment of invention is meant to promote a bottle of wine, the size of the plastic signage form and/or pocket may be the same size or may be smaller (in some cases, larger) than an actual bottle, and to allow for the curvature of the racking, when applicable.

### Plastic Signage:

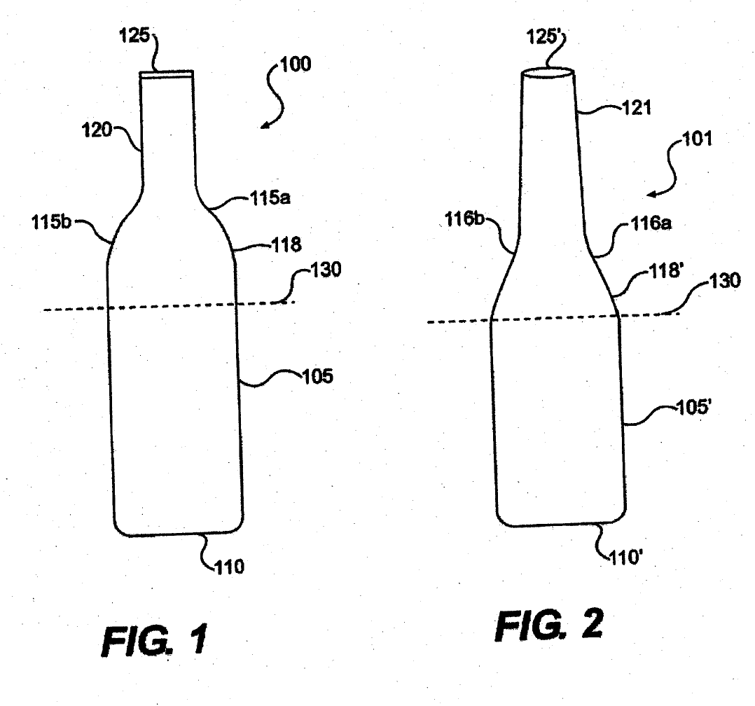

FIGS. 1 through 5 are illustrations of embodiments of signage according to principles of the invention. The signage may be made from plastic (perhaps vinyl and styrene material) and may alternatively be made from ecologically friendly materials that may decompose when discarded. The signage of the embodiments herein may also employ lenticular material (such as from a lenticular lens sheet) and affects, such lenticular materials may be obtained from Motion Products Corporation, for example. Other sources of lenticular material are known; this is just one example. Lenticular materials may also be laminated to other substrates, as necessary, and may be of various colors. Use of lenticulars may be sourced from other vendors. Because of the angle of display, there may be limited options for variations available for use on or as these signs.

Specifically, FIG. 1 illustrates exemplary signage comprising a die cut material 100 as described more herein. The die cut material may be in the shape of a “high-shouldered” bottle of wine (sometimes referred to as a “Bordeaux Bottle”), for example. The die cut material 100 may generally represent a cylindrical item such as a bottle, except in two dimensions, or alternatively two dimensions with lenticular surface aspects. Of course, any shape is possible for the die cut material and need not always conform to a particular shape of a product. The die cut material has a bottom 110 and a top 125. The die cut material 100 has a larger uniform portion 105 of generally the same width with a shoulder portion 115a, 115b that narrows to an extended narrow portion 120 (i.e., more narrow than the larger uniform portion). In this embodiment, the shoulder portion 115 is entirely above the central axis of the die cut material 100. The demarcation point 118 between the larger uniform potion and the shoulder is entirely above the horizontal axis.

In FIG. 2, the exemplary die cut material 101 includes a bottom 110′ and a top 125′ with a larger uniform portion 105′ substantially below the central horizontal axis 130. The shoulder portion 116a, 116b has a longer narrowing extent as compared with the shoulder portion 115 of FIG. 1. In this embodiment, the shoulders 116a, 116b are essentially above the central horizontal axis 130 (or, alternatively, begin the narrowing substantially proximate the horizontal axis). The demarcation point 118′ may be at the horizontal axis 130. FIG. 2 represents another common wine bottle shape, typically referred to as a “Burgundy Bottle.”

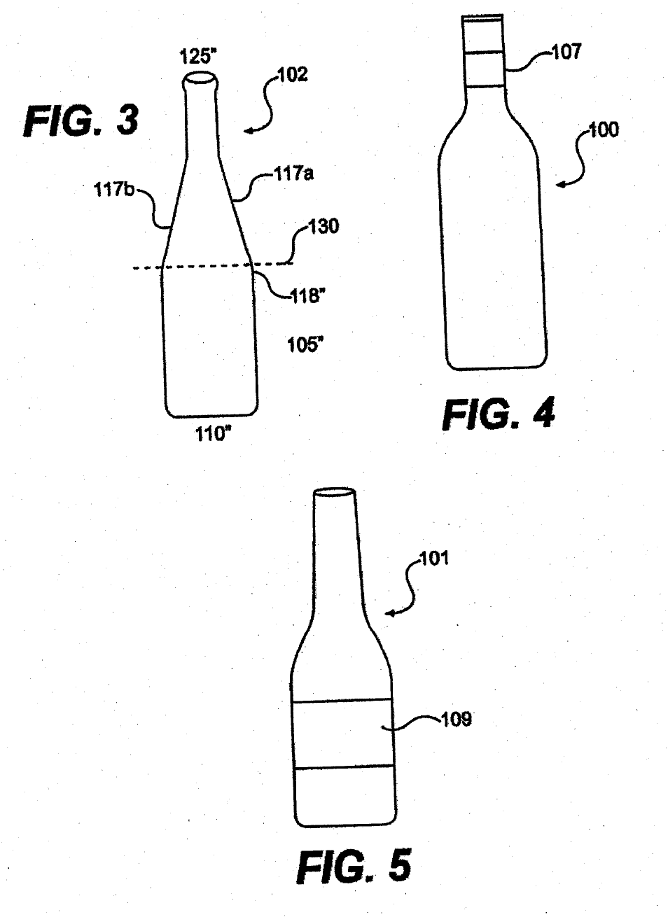

FIG. 3 is an exemplary illustration of signage, according to principles of the invention, generally denoted by 102, and representing another common wine bottle shape, referred to sometimes as a “Hoch Bottle.” In this embodiment, the demarcation point 118″ may be below the central axis. The width at the shoulders 117a, 117b is narrowing along substantially half (or more) of the total length of the signage (i.e., along substantially the demarcation point 118″ to the top 125″).

FIG. 4 is an exemplary illustration of signage and shows the embodiment of FIG. 1 configured for receiving a representation of variable copy and/or graphics. A pocket 107 would receive a graphic related to the product represented by the signage 100. Alternatively, the graphic (which might include text) may be printed directly on the signage 100 at the location designated by 107. The use of copy and/or imagery on the bottle shape may appear anywhere on the die cut bottle shape. In this example, the variable copy and/or imagery appears where a neck label traditionally appears (e.g., at location of 107) on an actual bottle of wine. This exemplary placement may be applicable to the signage of FIGS. 2 and 3, as well. The placement of the pocket or graphic may also be combined with any other placements on the die cut sign, including as represented in FIG. 5, e.g., at location designated as 109 (which may be the location of a pocket).

FIG. 5 is an exemplary illustration of signage that shows FIG. 2 with a pocket 109 configured to receive a representation of variable copy or graphics, according to specific applications of the invention. The use of copy and/or imagery on the bottle shape may appear anywhere on the die cut bottle shape. The graphic or copy may be applied directly onto the signage 101 without pocket 109. FIG. 5 shows as an example of the variable copy and/or imagery appearing in the place equivalent to where a printed label typically appears on an actual bottle of wine. That is, the pocket and/or placement of the graphic mimics the location where the equivalent graphic or copy would appear on the actual product (i.e., to make the signage appear as if it were the actual product itself). This possible placement may also apply to the signage of FIGS. 1 and 3, as well.

Each of these embodiments of FIGS. 1-5 preferably have typical thickness between 10 and 20 mil before adhesive (such as for styrene). Alternatively, embodiments of FIGS. 1-6 may have thicknesses of 0.005-0.020 inches (such as for plastic) but may be of other thicknesses as necessary, and potentially laminated with a variety of topcoats typically applied to the non-adhesive side, most frequently laminates, vinyl materials, or the like.

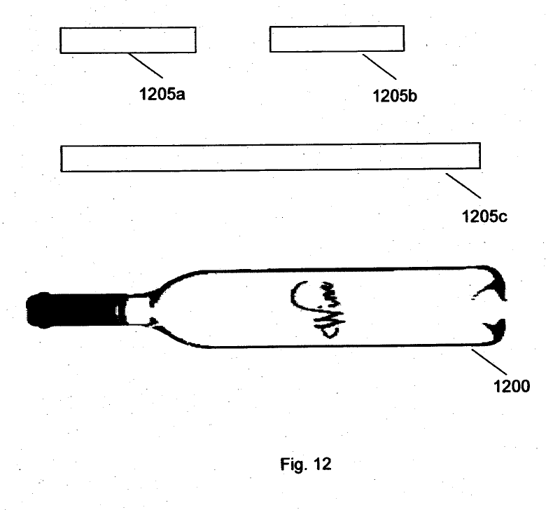

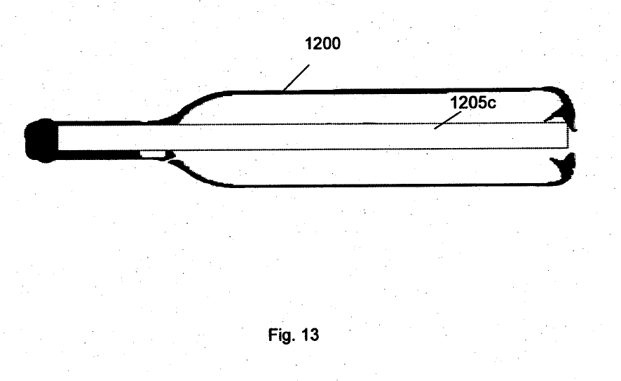

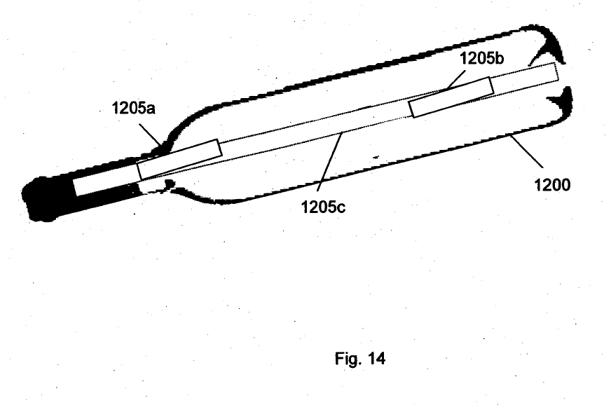

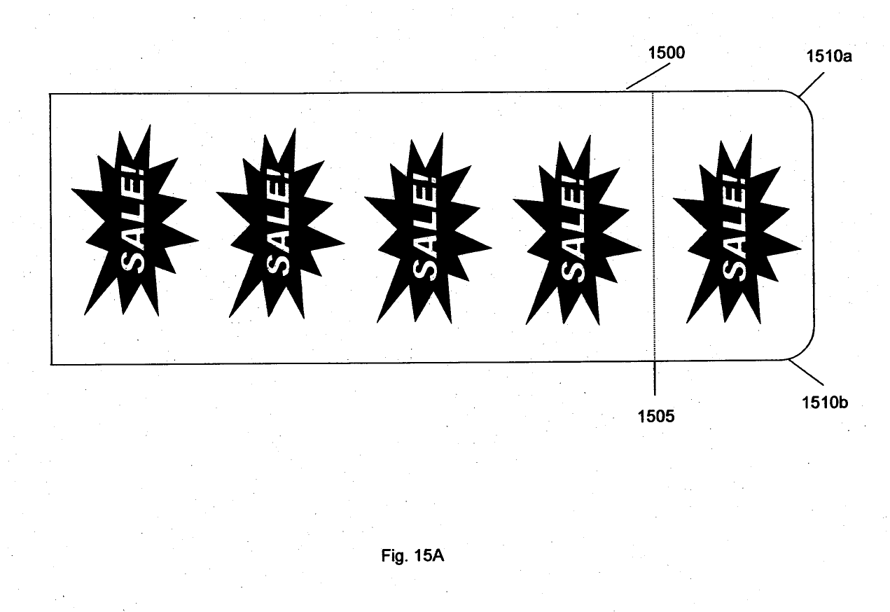

Either prior to shipment or by the recipient, the mode of affixing the sign to a wire rack is added. As seen in reference to FIGS. 12-14, one long strip of approximately 12″ long of a self-engaging fastener 1205c, such as available from Fasteners For Retail (FFR) Item 8808111903, and two 3″ long strips 1205a, 1205b of the same fastener may be cut. The 12″ strip 1205c is attached down the center of the back of the wine bottle sign 1200. When ready to adhere to a wine rack, one of the 3″ strips (e.g., 1205a) may be pressed into the self-engaging fastener 1205c on the back of the signage, wrapped around the wire of the rack towards the back (away from the installer) and pressed into the 12″ strip 1205c on the bottle signage. A second 3″ strip (e.g., 1205b) may be used to similarly affix the signage to the wire rack around the front support wire of the wine rack.

When it is time to move the sign to another location in the store, the process is completed in reverse, that is, the front 3″ strip is removed and then the back 3″ strip. Both can be temporarily pressed into the 12″ strip while moving to the new location or stored until the signage is next needed on the retail floor; at that time, in its new location, the process may be repeated.

The signage 1200 and fasteners 1205a, 1205b and 1205c may be provided pre-assembled, or may be provided as a kit that includes the signage 1200 and prefabricated fasteners 1205a, 1205b and 1205c separately so that the completed “ready to install” signage may be assembled at a store location prior to use.

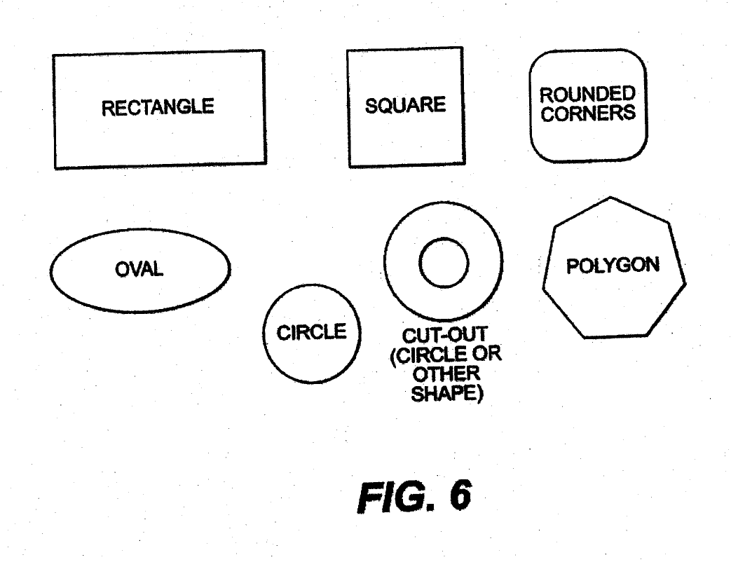

FIG. 6 is a set of illustrations showing various exemplary shapes signage may take, according to principles of the invention. As shown in the illustrations of FIG. 6, the signage may take the shape of the product being mimicked (mimicking a shape of a product is not a requirement though), and may appear as standard shapes, including but not limited to squares, rectangles, circles, ovals and stars, as well as die cut to particular shapes, including but not limited to wine bottle shapes, spirits bottle shapes, packaged goods shapes, shelving space (such as I-beams for lumber at lumber and hardware suppliers or in storage spaces where inventory must be accessible but is also frequently rotated and/or moves or changes). The plastic and/or magnets may be flexible to adjust to non-flat shelving units, such as wine racks. Lexan® may also be used in the embodiment of FIG. 6.

The embodiments of FIG. 1-6, may also include a combination of multiple magnets or a combination of plastic and pocket that are used together, for example, a die cut wine bottle shape with a customizable smaller label or pocket that is attached to the larger wine bottle shaped signage portion, which itself is attached, affixed or otherwise used with a wine racking system or other shelving unit. This would apply to any such combination of signage used at the shelving or point-of-purchase location, including pricing and barcode information applied alone or in conjunction with the standard or die cut versions described above.

Because of the large range of inventory SKUs in a retail location, even coming from a single supplier (e.g., a wine distributor who represents a large number of brands and SKUs), maximizing the benefit of signage and the resources required to install such signage by their staff is important, all the more so with the slim margins such retail locations have to operate within. Having a signage solution that can accommodate multiple messages throughout the year meets an additional need, when applied this way. The “pocket” variation readily addresses this need, by only needing to be installed once while having the particular message changed as needed.

In aspects, the signage may be oriented so that the signage is at an angle relative to vertical. In one aspect, the signage may be constructed so that a first portion of the signage may be oriented in a first direction, while a second portion may be oriented at another direction, so that an angle may be formed. The signage herein may be constructed so that the signage adheres by itself to store shelving or racks in any angle to vertical. The signage may include repositionable adhering portions that can be adjusted to grip parts of the signage at different spots to flexibly permit attaching of the signage at different locations on the signage to a rack or shelf. This aids in adjusting orientation to the signage to shelves or racks that may be at odd angles.

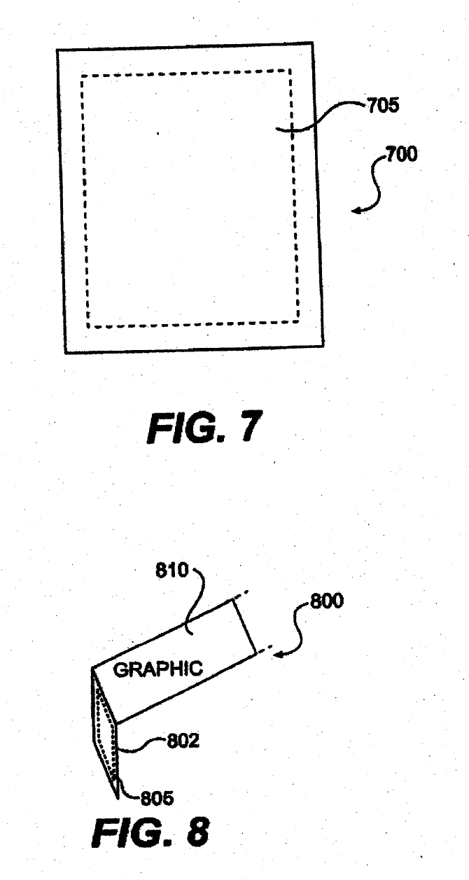

FIG. 7 is an exemplary illustration that represents a sample of a square or rectangular sign that can be customized for signage, according to principles of the invention. These would frequently be used for boxes of wine or packaged goods, such as paper, personal products, etc., that are sold on flat shelving. These would also frequently be used in stock rooms and for warehouse and retail stocking, as well as used for promotional messages. These would frequently be used for wine and spirits bottles that stand up-right on shelves, but has many additional applications, such as promotional messages (for example, “This week's special!”). The signage 700 may include a pocket 705 for receiving advertising inserts. The signage 700 may include lenticular aspects to provide visual affects (e.g., 3D affects).

FIG. 8 is an exemplary illustration of signage where a portion of the material of signage extends beyond the edge of the shelf or shelving on which the embodiment is used, generally denoted by reference numeral 800. This extension 810 typically may be bent portion 802. The signage may have a hook and loop fasteners or any variety of methods of adhering other materials and/or other signage (not shown). The bent portion 802 may include a pocket 805 adapted to receive an insert, perhaps to deliver a message or a graphic. The signage 800 may also include lenticular aspects.

FIGS. 7 and 8 may be prepared on a plastic or environmentally friendly material, cut to a rectangular shape. Traditionally the length is at least 14″ so that it extends sufficiently far back onto the gondola shelf so as to not be easily stolen and so that products further back on the shelf can easily slide forward by shoppers or those stocking the shelves. It is usually important that the height or profile of the signage be kept as low as possible so that products do not tip and are easily movable from side to side (that is on and off the signage). Signs will have an adhesive that is permanent to plastic (or whichever material is used in the particular instance) and repositionable to metal. There are currently few suppliers of such an adhesive. At present, International Tape Company product #4560 is used. This adhesive or “tape” is adhered to the entire back portion of the signage. That is, the sign may be repositional because the “tape” may be constructed employing two types of adhesives, i.e., that have different chemical properties. On a first side of the “tape,” a first type of adhesive may be configured to adhere to the signage itself and is generally permanent, while the “tape” may have a second side configured with a second type of adhesive that is not permanently adhering, but permits removal of the signage to be repositional. The different type of adhesives may be constructed to adhere to one type of surface such as plastic permanently (e.g., a signage surface made of plastic) while the second type of adhesive is “removable” for a second type of surface such as metal (such as a metal shelf surface).

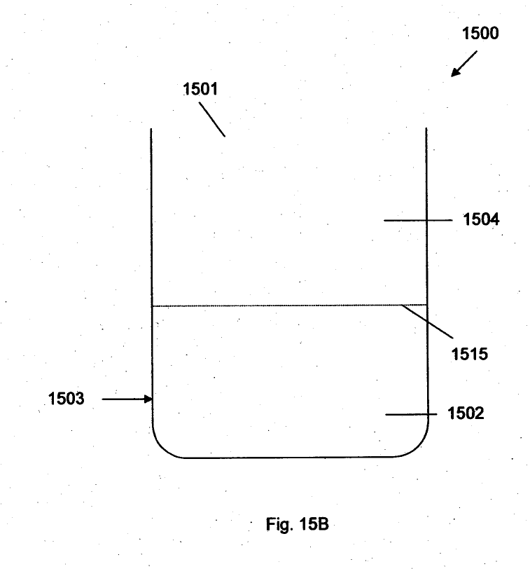

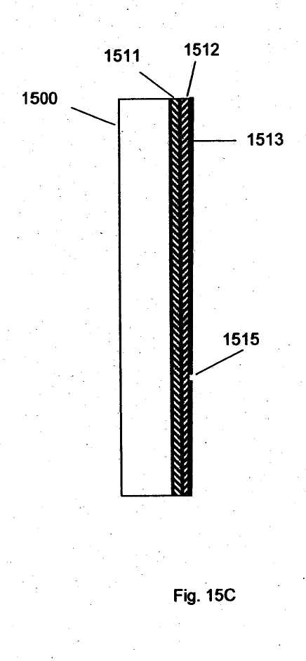

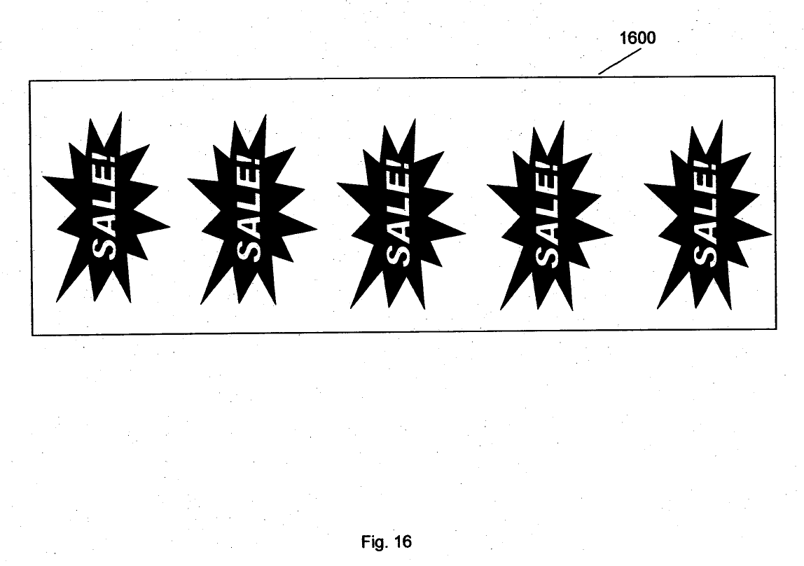

When the “tab” variation is incorporated into the gondola shelf version of the sign 1500 as shown in relation to FIGS. 15A and 15B, a slit 1515 is added to the tape adhered to the back 1501 of the signs. This slit 1515 aligns substantially with the score 1505 introduced to the plastic (or material used) on the front of the sign 1500 so that the adhesive is exposed on the portion of the sign to be affixed to the metal shelf while the adhesive remains covered by the protective liner 1502 for the portion of the sign that extends past the shelf edge creating a tab 1503.

To install the sign, a protective covering 1504 on the back of the sign is removed (if there is a tab, the covering is removed only up to the slit, the remaining covering is to remain on the back of the tab). The signage should be placed so that the front edge from which any indicia is to be read or viewed, excluding any tabs, is in line with the edge of the front edge of the gondola shelf, so that the signage ends prior to the start of the channel strip and/or vertical surface of the gondola shelf. When a tab is employed, the signage should be placed so that the score is in line with the edge of the front edge of the gondola shelf and the tab extends partly over or over the vertical surface. The signage should be smoothed down by hand down the center of the sign and out to the sides, all the way to the back corners of the sign, to ensure a good adhesion. Products would then be placed on top of the signage. When the sign needs to be moved, any remaining products should be removed from on top of the sign, and the back corner of the sign be peeled up, with a slow yet steady upward motion so that the sign safely removes from the metal gondola shelf. The signage should be positioned in its new location within a short amount of time to ensure maximum adhesion possible and no drying or reaction of the adhesive materials.

FIG. 15C is a side view of an exemplary illustration showing a “double-sided tape” as a fastener mechanism for a signage, constructed according to principles of the invention. This illustration is not drawn to scale with certain aspects enlarged. A “double-sided tape” is illustratively shown constructed having a first side 1511 and a second side 1512, and also shown as being attached to signage 1500. The first side 1511 may be constructed of a first type of adhesive that permanently bonds to the signage 1500. The first side 1511 adhesive may have a property that adheres permanently to a particular type of surface such as plastic. The second side 1512 may be a second type of adhesive that does not permanently bond to a surface and permits repositioning of the signage 1500. Also shown is a removable cover 1513 that may be removed to expose the second side 1512 when ready for attaching the signage 1500 to a surface, such as a shelf surface, for example.

When the “double-sided tape” is used in conjunction with tab signage such as the tab signage shown in relation to a signage of FIG. 15B, the “double-sided tape” 1511,1512 may be used as the fastening technique and may be constructed with a slit 1515 so that the “double-sided tape” 1511,1512 may more easily conform to and align with the score 1505 that partially aids in creating the tab 1503. The slit 1515 may be sufficiently deep to cut through the removable cover 1513, but not into the base material of the signage 1500 itself. The slit 1515 also permits removal of the cover 1513 up to the slit 1515. The slit 1515 assists in protecting the tab 1503 from exposed adhesive.

FIG. 16 is an illustration of a signage similar to FIG. 15A but without a tab portion, constructed according to principles of the invention, generally denoted by reference numeral 1600. The signage 1600 may be constructed with a fastening mechanism which may include an adhesive system such as a “double-sided tape” with two different types of adhesive to permit repositioning of the signage, or a hook and loop fastening mechanism.

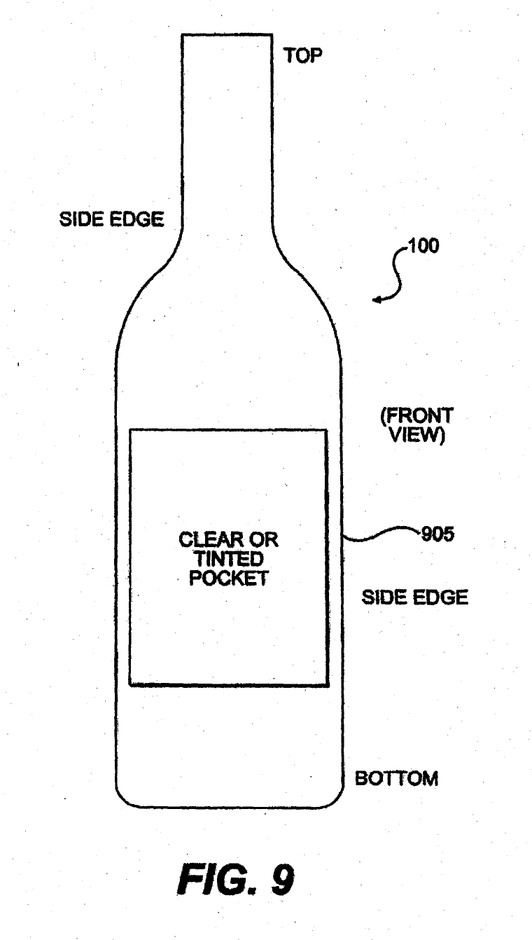

FIG. 9 is an illustration of additional aspects of signage that represents a wine bottle of FIG. 1, according to principles of the invention. Although, FIG. 9 uses a wine bottle shape as an example, the pocket aspect may apply to any other shapes and variations as discussed herein. FIG. 9 shows a clear or tinted pocket 905 that can be attached either magnetically, by a hook, or with an adhesive, according to principles of the invention. This pocket is typically sealed on three sides with one side open so an insert inserted into the pocket 905 can be changed as necessary for changing applied situations. These insertions may be magnetic, paper or other materials. The pocket on FIG. 9 is shown with the opening on the top for reference only—the location of the open side may vary, and may be on any side, or even on the back or front using a sleeve flap opening, but is typically along one side of the pocket such as the left side.

### Plastic Pockets:

Either independently or in combination with the above described signage, these same shapes and their respective variations may be produced entirely or portions thereof as plastic pockets. These plastic pockets allow for magnetic, paper or other materials to be inserted into the pockets for customization, variation, etc. Typically, these pockets will be made of a clear or tinted plastic and sealed on three sides (open side location may vary). Thus, FIGS. 1, 2, 3, 6, 7 and 8 illustrate certain aspects of signage provided by certain embodiments of the invention that can be made from plastic, optionally with either a full-size clear or tinted plastic pocket overtop or have a smaller clear or tinted plastic pocket affixed somewhere on the plastic signage shape. The signage may have a magnet, adhesive, clips, holes, hooks, hook and loop such as Velcro®, snaps or other suitable methods of adhering or affixing the signage to a shelving unit or display platform, self-engaging fasteners being preferable for racks, and repositionable adhesives for gondola shelves.

FIG. 4 and FIG. 5 may also illustrate aspects of signage of the invention made of plastic with clear or tinted plastic pockets over top a based form. Again, the placement and/or number of these pockets are exemplary. The number, quantity and placement of these pockets may vary.

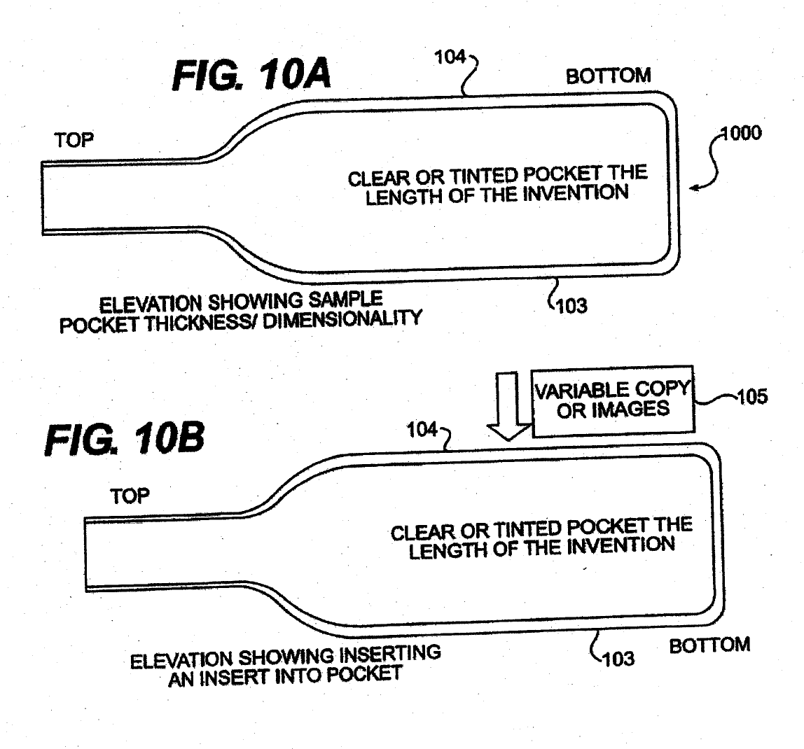

FIG. 10A is an illustration that represents a side view with elevation when the advertising device of the invention is produced as a pocket, according to principles of the invention, generally denoted as reference numeral 1000. The width of the advertising device 1000 is determined by the thickness of the backing (if magnetic, type of plastic substrate, adhesives, clips and/or other methods of affixing invention to racks and shelving units), if the entire advertising device 1000 comprises a pocket (as in FIG. 10A) or only a portion of the invention has a pocket attached. Reference numeral 103 represents the clear or tinted plastic layer that is affixed to a die cut backing, magnetic, plastic, or similar material. Reference numeral 104 indicates a sample opening for inserting and removing variable inserts, which may run a portion of the length of the advertising device 1000. FIG. 10B is the illustration of FIG. 10A but showing the insertion of a variable insert 105 into the pocket at sample opening 104.

Any of the embodiments herein may include an attaching mechanism for attaching to a rack, display platform, or a shelf including magnetically, by a hook, clasp, hole, or with an adhesive, according to principles of the invention. Moreover, the signage may continue past a shelving edge, usually with a curved edge or corners.

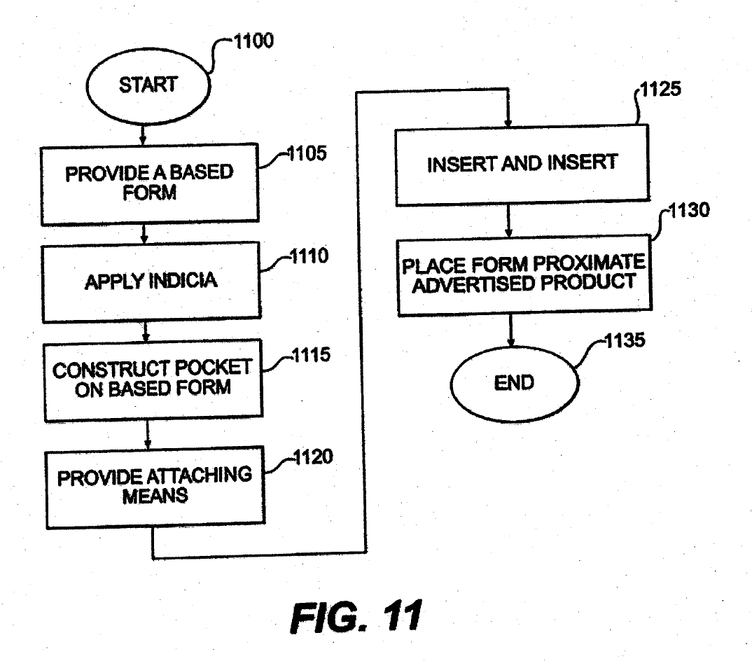

FIG. 11 is a flow diagram of an embodiment showing steps of making and/or using the signage, according to principles of the invention, starting at step 1100. At step 1105, a based form may be provided that may include a plastic form (perhaps die cut) and may be a magnetic based form. Other types of materials may be used, for example, vinyl or lenticular material. Also, in some signage, a portion (wherein the portion might be the entire based form, or less that the entire based form) of the based form may include lenticulated material. The based form may or may not be of a size of an associated product to be advertised, but is often of a similar form. At step 1110, indicia may be applied. This may include a hologram, perhaps an image representing or associated in some fashion with a product to be advertised by the based form. It may be a 3D image.

At step 1115, an optional pocket(s) may be constructed on the based form for receiving an insert for advertising a product. At step 1120, an attaching means may be provided, for attaching the based form to a display platform (e.g., shelf, rack, wall, counter, beam, and the like). This attaching means might include any of a magnetic fastener (which may be inherent in the based form), a hook, adhesive, snaps, hook and loop such as Velcro®, friction fit couplers, holes for sliding over a hook, and the like. At step 1125, an insert(s) may be inserted into the pocket(s). Typically, the insert advertises the associated product. At step 1130, the based form and any inserts may be placed proximate an advertised product so that a constant display may be attained even when a product is “sold-out” or otherwise not available. At step 1135, the process ends.

In one embodiment, signage may be made by selecting an appropriate pattern for the signage that represents a product. In other embodiments, the signage is not related to the shape of a product, but may be any form that is suitable for delivering a message or concept, and could be sized based on the length (or depth) of a display rack, or shelf partition, for example.

As needed or desired, in one aspect, the invention may be moved by removing the sign from its display location and attaching to another display location. When combinations of signs and pockets are used, the inserts placed within the pockets may be removed and, if appropriate, replaced with other inserts. For example, “This week's special!” may be moved on a weekly basis to different applications of the invention, whereas the original sign or pocket invention remains in place.

The signage may be constructed with at least one bend (perhaps several) that forms at least two portions at an angle to one another so that at least one portion is viewable to a customer while the other portion is not readily viewable, except when action is taken to cause the other portion to become visible. In some versions the adhering material may be flexibly relocatable on the signage, while still maintaining self-adhering capability.

Repositionable signage herein may use an adhesive technique that involves two types of adhesives at the same time: a permanent type of adhesive and a second type of adhesive that permits repositioning. For example, a double-sided tape may be constructed so that on one side it may comprise a type of adhesive that holds permanently to the signage (i.e., one type of chemical composition) while the other side of the double sided tape may comprise a second type of adhesive that permits removal of the signage from a shelf or rack without damage to the signage or adhesives, which permits repositioning of the signage to another location. The “double-sided tape” may also be provided with removable covers that can be peeled off a side of the tape when ready for use and applied to the signage and/or a rack or shelf. This technique may be employed in the various embodiments herein.

Various modifications and variations of the described methods and systems of the invention will be apparent to those skilled in the art without departing from the scope and spirit of the invention. Features of one embodiment may be incorporated with features of another embodiment. The signage and fastening mechanisms herein may be produced as kits for assembly by an end user. Although the invention has been described in connection with specific preferred embodiments, it should be understood that the invention as claimed should not be unduly limited to such specific embodiments. Indeed, various modifications of the described modes for carrying out the invention which are obvious to those skilled in advertising or related fields are intended to be within the scope of the following claims.

What is claimed is:

1. An apparatus for marketing products, comprising:
a signage configured to represent substantially in shape and size a product being advertised by the die cut signage and the signage adapted to receive indicia representative of information associated with the advertised product; and
a first self-engaging fastener for securing the signage applied along the extent of the signage and adapted to receive a pair of second self-engaging strips to secure the signage to a rack;
wherein the signage has one portion of width above a central horizontal axis different in width than a portion below the central horizontal axis.

2. The apparatus of claim 1, wherein the die cut signage includes a pocket adapted to receive an insert for advertising.

3. The apparatus of claim 2, wherein the pocket is plastic.

4. The apparatus of claim 1, wherein the second self-engaging strips comprise adhering material that is relocatable on the signage and permitting adherence to a wire rack.

5. The apparatus of claim 1, wherein the indicia comprises an insert for advertising the corresponding product.

6. The apparatus of claim 1, wherein the signage has a central horizontal axis and includes a first portion wider than a second portion, the second portion having a width that narrows along a length of the second portion, the transition from the first portion to the second portion being a demarcation point.

7. The apparatus of claim 6, wherein the demarcation point is below the central horizontal axis.

8. The apparatus of claim 6, wherein the demarcation point is above the central horizontal axis.

9. An apparatus for advertising, comprising a signage having a form corresponding to a general form of an associated product to be advertised wherein the signage has a first surface and a second surface and the signage configured with a fastening mechanism for affixing the signage to a display platform, the fastening mechanism comprising a first fastening portion attached to the second surface and arranged along a length of the signage and at least one second fastening portion configured to engage the first fastening portion, the at least one second fastening portion attachable to a display platform and configured to be engageable with the first fastening portion.

10. The apparatus of claim 9, wherein the first fastening portion and the at least one second fastening portion provides for the signage to be removable and relocatable from one location to another location.

11. The apparatus of claim 9, wherein the at least one second fastening portion comprises a plurality of second fastening portions, each second fastening portion being shorter in length than the first fastening portion.

12. The apparatus of claim 9, wherein the length of the first fastening portion is substantially a total length of the signage.

13. The apparatus of claim 9, wherein the first surface includes imagery or information related to the associated product.

14. A method of advertising, comprising the steps of:
providing a based form substantially sized and shaped to represent an advertised product;
applying indicia on the based form representing information associated with the advertised product; and
placing the based form proximate a location of an actual product represented by the based form and applied indicia to visually convey the advertised product to a potential customer so that the indicia continues to convey the information when the actual product is out of stock or not directly viewable by the potential customer.

15. The method of claim 14, further comprising constructing at least one pocket on the based form to receive an insert for advertising.

16. The method of claim 14, further comprising providing a fastening mechanism for affixing the based form to a display platform, the fastening mechanism comprising a first fastening portion attached to the second surface and arranged along a length of the based form and at least one second fastening portion configured to engage the first fastening portion, the at least one second fastening portion attachable to a display platform and configured to be engageable with the first fastening portion.

17. The method of claim 16, wherein the first fastening portion and the at least one second fastening portion provides for the based form to be removable and relocatable from one location to another location.

18. The method of claim 14, wherein the based form is substantially plastic.

19. The method of claim 14, further comprising attaching an adhesive fastening mechanism to the based form.

20. The method of claim 19, wherein the attaching step attaches a adhesive fastening mechanism comprising a first type of adhesive and a second type of adhesive.

21. The method of claim 20, wherein the first type of adhesive adheres to the based form substantially permanently and the second type of adhesive permits removal and reattachment of the based form to another surface.

22. An apparatus for marketing products, comprising:
a signage having a front side and a back side and adapted to receive indicia representative of information associated with the advertised product on the front side; and
a score imparted into a front side of the signage to permit bending of the signage along a width of the signage thereby forming a tab.

23. The apparatus of claim 22, further comprising adhesive arranged on the back side configured with a removable cover for attaching the signage to a shelf.

24. The apparatus of claim 23, wherein the adhesive comprises a first type of adhesive that permanently adheres to the signage and a second adhesive type that removably adheres to a surface.

25. The apparatus of claim 23, further comprising a slit formed in the removable cover to permit removal of a portion of the cover for attaching the signage to a shelf.

26. The apparatus of claim 25, wherein the slit is aligned with the score thereby permitting the tab to hang over a shelf end and also assisting in protecting the tab from exposed adhesive.

27. An apparatus for marketing products, comprising:
a signage having a front side and a back side and adapted to receive indicia representative of information associated with the advertised product on the front side; and
a fastener arranged on the back side for attaching the signage to a shelf.

28. The apparatus of claim 27, wherein the fastener comprises an adhesive, wherein the adhesive comprises a first type of adhesive that permanently adheres to the signage and a second type of adhesive that removably adheres to a surface.
